(19) United States
(12) Patent Application Publication
(10) Pub. No.: US 2025/0322005 A1
(43) Pub. Date: Oct. 16, 2025

(54) SYSTEM AND METHOD FOR WEIGHTED IDENTITY RETRIEVAL

(71) Applicant: Microsoft Technology Licensing, LLC, Redmond, WA (US)

(72) Inventors: Kevin Corley Wonus, Haymarket, VA (US); Kushagra Thapar, Seattle, WA (US); Miles Patrick, Columbia, MD (US); Xin Liang, Issaquah, WA (US)

(21) Appl. No.: 18/637,046

(22) Filed: Apr. 16, 2024

(51) Int. Cl. G06F 16/383; G06F 16/33

(52) U.S. Cl. CPC G06F 16/383; G06F 16/3347

(57) ABSTRACT

A method, computer program product, and computing system for processing a query for obtaining data from an unstructured database. A parsed representation of a query field of the query is generated by parsing the query field from the query. A fuzzified representation of the query field is generated by fuzzifying the parsed representation of the query field. A vectorized representation of the query field is generated by vectorizing the fuzzified representation of the field. A matching input field is identified from the unstructured database by processing the vectorized representation of the query field. The matching input field is scored based upon, at least in part, weighting from a domain model. A weighted result is provided to the query using the scoring of the matching input field.

### BACKGROUND

The storage of semi-structured and unstructured data presents a challenge: should a structure be imposed on incoming data by enforcing a schema, or should any and all incoming data be accepted regardless of content type or underlying structure? There is momentum in the field of storage applications to embrace unstructured or semi-structured data as this approach maximizes the flow of incoming data, irrespective of content or format.

However, querying such data is fraught with difficulties. Data analysts and downstream systems have no guarantees with respect to content type or data quality. Some solutions allow weighting on search terms, but this by itself does not define a formal model for storing and retrieving unstructured data. Relational databases have long managed a formal schema within their system catalogs and offer referential integrity, but little has been done to reduce the issues of processing data with “no schema” for “NoSQL” databases.

### BRIEF DESCRIPTION OF THE DRAWINGS

FIG. 1 is a flow chart of one implementation of the querying of data from an unstructured database using a weighted identity retrieval process;

FIG. 2 is a diagrammatic view of an exemplary architecture of the weighted identity retrieval process;

FIG. 3 is a flow chart of one implementation of the ingesting of input data into the unstructured database using the weighted identity retrieval process;

FIG. 4 is a diagrammatic view of ingesting input data into the unstructured database using the weighted identity retrieval process;

FIG. 5 is a diagrammatic view of querying data from the unstructured database using the weighted identity retrieval process; and FIG. 6 is a diagrammatic view of computer system and a weighted identity retrieval process coupled to a distributed computing network.

Like reference symbols in the various drawings indicate like elements.

### DETAILED DESCRIPTION

Implementations of the present disclosure provide a process for identifying real-world named-entities (e.g., person names, countries, companies, proper nouns generally) with any number of identifying properties on a dataset by generating an entity-model overlay. The weighted identity retrieval process enables users to define variable weights on identifying properties identified from an input dataset. Variable weights are applied to properties during ingestion but can be overridden during search operations. As will be described in greater detail, ingested weights can be generated automatically using generative artificial intelligence (AI) model pipeline, or explicitly applied by a user during model definition. Accordingly, the entity or domain model governs the default weights for all properties on any defined entity.

Searching or querying of data in unstructured databases is accomplished using the weighted identity retrieval process by leveraging vector-search capability (and other types of search methodologies) in a database. Candidate matching input fields are filtered using rigorous index-type-specific similarity-assessment that enables both high-recall along with high-precision.

Accordingly, implementations of the present disclosure describe processing a query for obtaining data from an unstructured database. A parsed representation of a query field of the query is generated by parsing the query field from the query. A fuzzified representation of the query field is generated by fuzzifying (i.e., process of introducing variability or imprecision into text data to enhance robustness or address variations in known data types) the parsed representation of the query field. A vectorized representation of the query field is generated by vectorizing (i.e., converting textual data into numerical vectors) the fuzzified representation of the field. A matching input field is identified from the unstructured database by processing the vectorized representation of the query field (i.e., storing an index representation of a vectorized representation into an unstructured database as a phonemic index, a temporal index, and/or a verbatim index). The matching input field is scored based upon, at least in part, weighting from a domain model. A weighted result to the query is provided (e.g., to a user or system providing the query) using the scoring of the matching input field.

In this manner, weighted identity retrieval process enables users (e.g., data analysts) to obtain identifying information from unstructured repositories, without filtering out non-conforming data, while maintaining the data-integrity of the incoming raw dataset. This also allows enrichment processing (i.e., enriching by data transformation), fuzzy searching, weighted property discrimination, and a straight-forward query algebra that retrieves high-scoring results.

The details of one or more implementations are set forth in the accompanying drawings and the description below. Other features and advantages will become apparent from the description, the drawings, and the claims.

### The Weighted Identity Retrieval Process

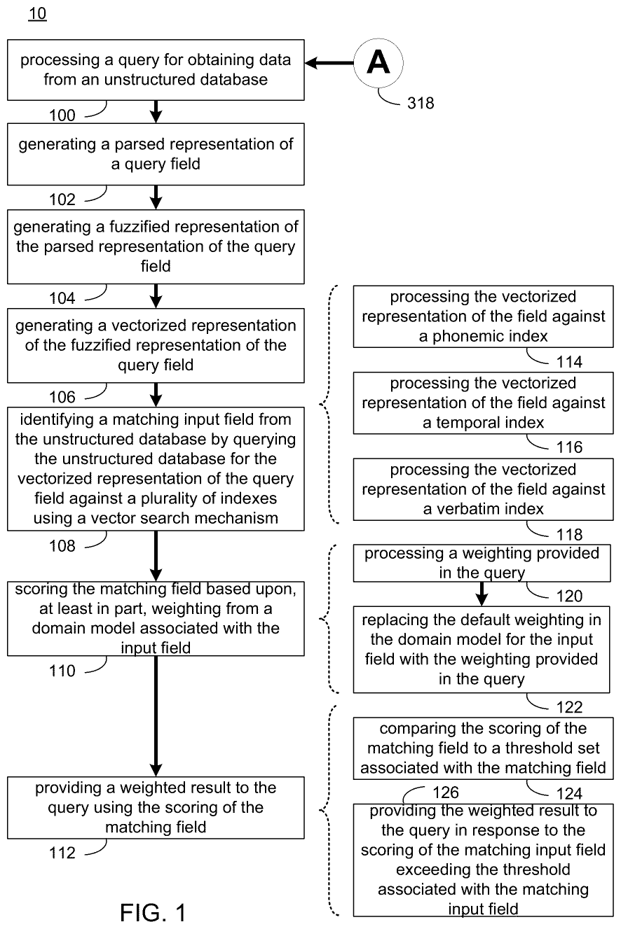

Referring to FIGS. 1-5, weighted identity retrieval process 10 processes 100 a query for obtaining data from an unstructured database. A parsed representation of a query field of the query is generated 102 by parsing the query field from the query. A fuzzified representation of the query field is generated 104 by fuzzifying the parsed representation of the query field. A vectorized representation of the query field is generated 106 by vectorizing the fuzzified representation of the field. A matching input field is identified 108 from the unstructured database by processing the vectorized representation of the query field. The matching input field is scored 110 based upon, at least in part, weighting from a domain model. A weighted result to the query is provided 112 (e.g., to a user or system providing the query) using the scoring of the matching input field.

In some implementations, weighted identity retrieval process 10 retrieves real-world named entities (e.g., person names, countries, companies, proper nouns generally) using fuzzified and vectorized index representation with just a limited number of index types (i.e., a phonemic index, a temporal index, and/or a verbatim index). For example, these named entities are unlike common nouns as they lack synonyms or antonyms. Additionally, named entities are susceptible to variations or misspelling. Accordingly, weighted identity retrieval process 10 uses fuzzified and vectorized representations to process unstructured data using three index types. As will be discussed in greater detail below, during ingestion, fields of input datasets corresponding to named-entities are indexed independently using a domain-model overlay. During query, fields are fetched from each of the three index collections and are scored by cosine similarity. Fields exceeding a threshold are synthesized into records. Once synthesized, the entire record is assessed using a query model by using a designated assessment method associated with an index-type from whence the field was matched.

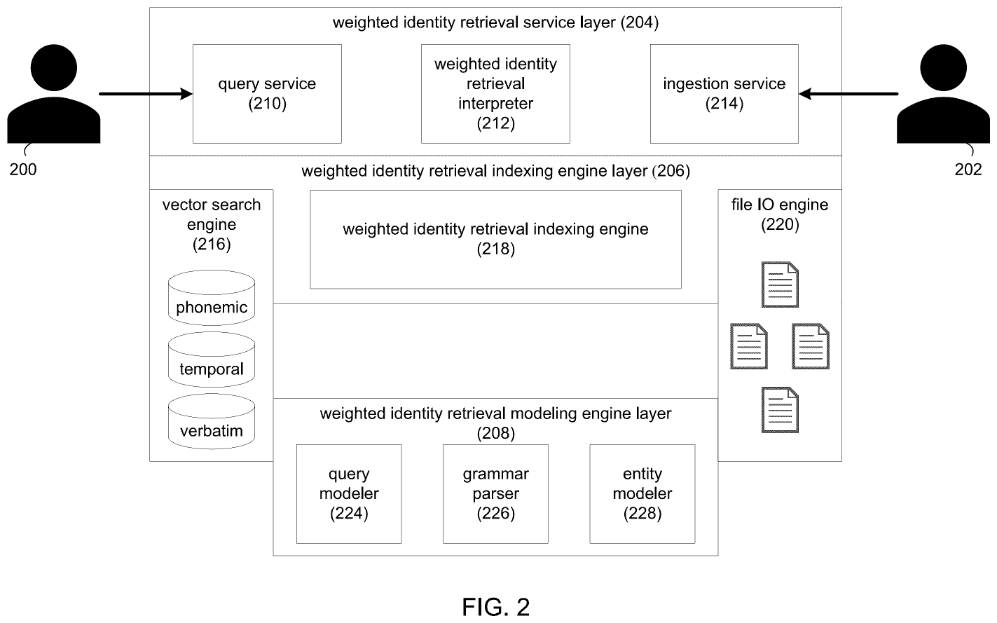

Referring also to FIG. 2, an example architecture of weighted identity retrieval process 10 is shown including the interactions of two different types of users (e.g., data analysts (e.g., data analyst 200) or a data analysis system) who query data from an unstructured database and data engineers (e.g., data engineer 202) or a data querying system) who store data or manage stored data within the unstructured database). As shown in FIG. 2, there are three layers (e.g., weighted identity retrieval service layer 204; weighted identity retrieval indexing engine layer 206; and weighted identity retrieval modeling engine layer 208) to represent the ingesting of unstructured data and the querying of unstructured data using weighted identity retrieval process 10. In some implementations, weighted identity retrieval service layer 204 includes a query service (e.g., query service 210); a weighted identity retrieval interpreter (e.g., weighted identity retrieval interpreter 212); and an ingestion service (e.g., ingestion service 214). Query service 210 is a software and/or hardware component that manages the processing of a query for data from an unstructured/semi-structured database. Ingestion service 214 is a software and/or hardware component that manages the processing of input datasets for storage in the unstructured/semi-structured database.

In some implementations, weighted identity retrieval interpreter 212 is a software and/or hardware component that converts the query from query service 210 and/or the request to store an input dataset from ingestion service 214 into a query model. The query itself is expressed in a domain specific language (DSL) by the user using a formal grammar. That grammar, parsing expression grammar (PEG), context free grammar (CFG), or any other similar formalized grammar stipulates the query/indexing request using weighted identity retrieval indexing engine layer 206. The DSL is a description of syntax in the form of a set of rules. For example, weighted identity retrieval interpreter 212 includes a set of rules that define how the query and/or the input dataset is parsed. In one example and as will be described in greater detail below, weighted identity retrieval interpreter 212 parses a query into multiple fields. Similarly, weighted identity retrieval interpreter 212 processes each record of an input dataset and, for each record, parses the record into multiple fields. In some implementations, a field of a query or a record is a distinct property or entity of the query or input dataset. For example, fields include entities such as a name, an address, a postal/ZIP code, an IP address, etc. As will be discussed in greater detail below, fields can be defined using an entity model. An entity model defines how data is indexed based upon labels and default values for a particular entity. For example, a “person” entity model (i.e., “Person-Entity”) includes various fields (e.g., “name”, “citizenship”; “address.city”; “address.state”; etc.). As will be described below in greater detail below, various fields are assigned with default weightings used to process subsequent queries involving that field.

In some implementations, weighted identity retrieval indexing engine layer 206 includes vector search engine (e.g., vector search engine 216); weighted identity retrieval indexing engine 218; and a file input-output (IO) engine (e.g., file IO engine 220). Vector search engine 216 is a software and/or hardware component that processes vectorized searches of a database. As will be described in more detail below, an unstructured database includes various index collections to categorize the data. In one example, the unstructured database includes three indexes: a phonemic index (i.e., an index for data categorized by phonemic properties or properties of spoken words), a temporal index (i.e., an index for data categorized by time-related properties), and a verbatim index (i.e., an index for data represented exactly as provided (e.g., phone numbers, postal codes, IP addresses, etc.)). However, it will be appreciated that any number of indexes may be used to represent different data types within the scope of the present disclosure. As will be discussed in greater detail below, weighted identity retrieval indexing engine 218 is a software and/or hardware component that includes sub-components that perform vectorizing of fields, assessing of fields, and record synthesizing. File IO engine 220 is a software and/or hardware component that manages the processing of input datasets to be stored or indexed in an unstructured database.

In some implementations, weighted identity retrieval modeling engine layer 208 includes query modeler 222; grammar parser 224, and entity modeler 226. Query modeler 222 is a software and/or hardware component that compiles a query expression to generate a query model. Grammar parser 224 is a software and/or hardware component that parses input fields and/or query fields using a formal grammar that represents the domain specific language (DSL). Entity modeler 226 is a software and/or hardware component that compiles an entity model (or multiple entity models) to generate a domain model. With the architecture shown in FIG. 2, weighted identity retrieval process 10 is able to ingest and retrieve named entities using fuzzified and vectorized index representations with just three index types.

### Domain Models

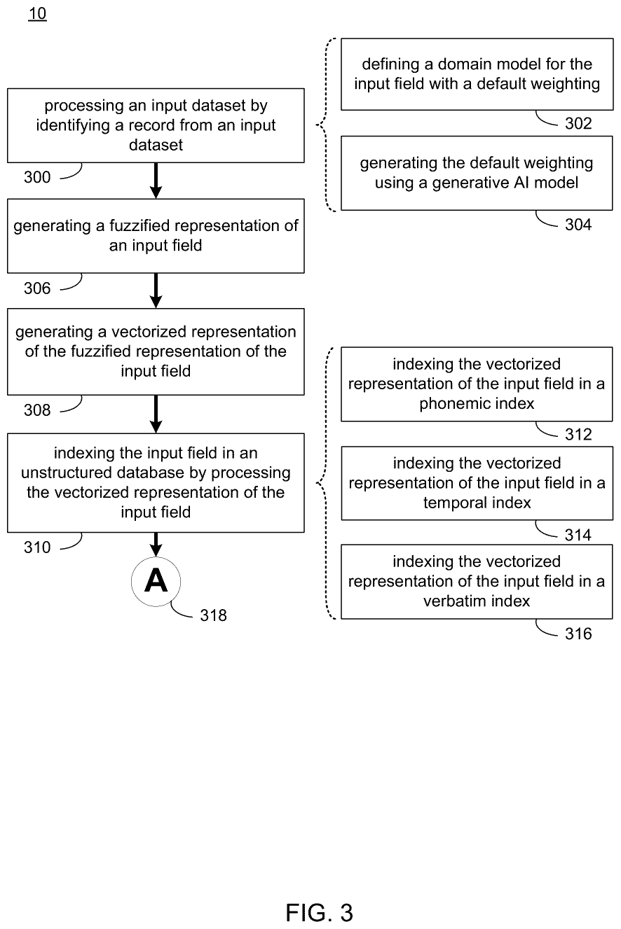

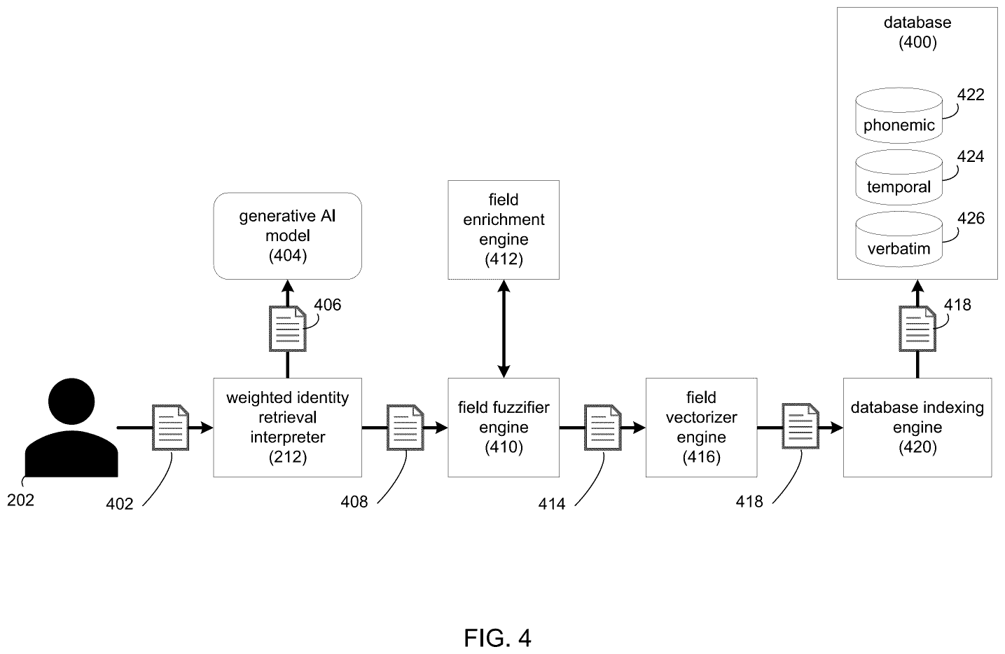

Referring also to FIG. 3 and in some implementations, weighted identity retrieval process 10 processes 300 an input dataset by identifying a record from the input dataset. An input dataset is a collection of documents, files, or other data content that is provided for storage and/or indexing within an unstructured/semi-structured database. Each input dataset can be reduced to a collection of fields (e.g., input fields). Referring also to FIG. 4 and in one example, an input dataset is received from a user or system for storing and indexing within an unstructured database (e.g., database 400). In some implementations, the request to ingest an input dataset (e.g., input dataset 402) includes a new entity model to associate with input dataset 402 and/or a reference to an existing entity model to associate with input dataset 402. An example of an entity model is shown below for a “Person-entity”:

| | |
|---|---|
| Person.Name: | Phonemic-Index(75) |
| Person.Citizenship: | Verbatim-Index( 6) |
| Person.Nationality: | Verbatim-Index( 9) |
| Person.DOB: | Temporal-Index(45) |
| Person.Address.City: | Phonemic-Index(25) |
| Person.Address.State: | Verbatim-Index(25) |
| Person.Phone: | Verbatim-Index(45) |
| “dob” | -> Person.DOB |
| “date-of-birth” | -> Person.DOB |
| “date of birth” | -> Person.DOB |
| “fullname” | -> Person.Name |
| “alias” | -> Person.Name |
| “contact_info” | -> Person.Address |
| GetCountryCode(“citizenship”) | -> Person.Citizenship |
| GetCountryCode(“nationality”) | -> Person.Nationality |
| GetCountryCode(“place-of-birth”) | -> Person.Nationality |
| ExtractPhone(“address_and_phone”) | -> Person.Phone |
| ExtractAddressCity(“address_and_phone”) | -> Person.Address.City |
| ExtractAddressState(“address_and_phone”) | -> Person.Address.State |

In some implementations, weighted identity retrieval process 10 defines 302 a domain model for the input field with a default weighting. As discussed above, when weighted identity retrieval process 10 processes a request to ingest input dataset 402, weighted identity retrieval process 10 compiles entity model(s) associated with input dataset to generate a domain model. Continuing with the above example, weighted identity retrieval process 10 defines a domain model using the “Person-entity” entity model described above. As shown above, “Person-entity” entity model includes predefined or default weights or weighting for each input field (e.g., Person.Name->Phonemic-Index(75), where “75” is a value ranging from 0-100 with greater values indicative of greater weight). In this example, the field “person.name” is weighted with a value of 75 for the phonemic index within database 400. This weighting indicates that the phonemic properties of the text associated with name are valuable for identifying corresponding records from database 400. For example, suppose an input field lists “John Smith”. As this is field is phonemically similar to “Jon Smythe” and “Jon Smith”, it is weighted such that queries for phonemically similar fields are included when querying an unstructured database. In another example, suppose an input field lists “01-10-1900”. As this field is temporally similar to “January 10, 1900” and “1/10/1900”, it is weighted (i.e., Person.DOB->Temporal-Index(45)) such that queries for temporally similar fields are included when querying an unstructured database. In some implementations, the default weighting of the domain model is defined by the user providing the input dataset for ingestion.

In some implementations, defining 302 the domain model for the input field includes generating 304 the default weighting using a generative AI model. For example, when processing a request to ingest input dataset 402, a user may not provide (or have a sense) regarding weighting for each input field of the input dataset. Accordingly and in some implementations, weighted identity retrieval process 10 includes a generative AI model (e.g., generative AI model 404) that processes input dataset and/or an associated entity model to generate a default weighting. Generative AI model 404 is configured to receive natural language prompts and/or example entries and/or contextual information concerning an incident to generate a response. In some implementations, the candidate triage group generative AI model includes a Large Language Model (LLM). A LLM is a language model consisting of a neural network with many parameters (typically billions of weights or more), trained on large quantities of unlabeled text using self-supervised learning or semi-supervised learning. In some implementations, generative AI model 404 is trained using conventional training approaches with the weighting of input fields in existing datasets based on the historical importance of each input field in the respective dataset. For example, for an end user, if historically, the user has prioritized SSN field over lastName field in their searchable data sets and the user has some internal documentation on this prioritization, this internal documentation is used to train generative AI model 404 to produce weights favoring the SSN field over the lastName field. In some implementations, weighted identity retrieval process 10 provides parsed fields to generative AI model 404 (e.g., an LLM) in the form of prompts (e.g., prompt 406 requesting a weight value to be recommended for a particular field and index type) to obtain a default weighting for each parsed field.

In this example, input dataset 402 includes multiple records or individual subsets of data. Accordingly, weighted identity retrieval process 10 (utilizing weighted identity retrieval interpreter 212) to convert input dataset 402 from ingestion service 214 using a formal grammar). In this example, weighted identity retrieval process 10 parses input dataset 402 into multiple records and interprets each record individually to identify each field. For example, weighted identity retrieval process 10 parses a record into multiple fields (i.e., parsed representation 408 of a record of input dataset 402). In this example, a record of input dataset 402 is shown below:

```
{
  address_and_phone: “100 Main St. / Enumclaw, WA (phone: 571-555-1212)”
  Address: “100 Main St. / Enumclaw, WA”
  Fullname: “John Doe”
  Vehicle: “Ford Explorer”
}
```

In some implementations, weighted identity retrieval process 10 generates 306 a fuzzified representation of an input field by fuzzifying the input field in the record. Fuzzifying or fuzzification is the process of introducing variability or imprecision into text data to enhance robustness or address variations in known data types. This is represented in FIG. 4 as “field fuzzifier engine 410”. In some implementations, weighted identity retrieval process 10 fuzzifying an input field includes generating similar representations for the input field. For example, weighted identity retrieval process 10 uses the default weighting to determine which type of fuzzification to perform on each input field.

In the context of phonemic fuzzification, weighted identity retrieval process 10 generates phonemically similar representations based upon, at least in part, a phonemic similarity metric and the International Phonetic Alphabet (IPA). For example, weighted identity retrieval process 10 performs phonemic fuzzification by converting the parsed input field into a phonetic representation using IPA. In one example, the process of fuzzy matching (i.e., assigning similarity scores to pairs of strings instead of seeking exact similarity) is used to generate phonemically similar values for the input field. In this example, a person name of “John Smith” is fuzzified into “Jonathan Smythe” and a town name of “Austin” is fuzzified into “Awstyn”. In another example, a process of phonemic-centric searching (i.e., generating a phonemic index for the input field and matching the phonemic index with an inverted index database, where the inverted index database includes a first inverted index corresponding to phonemic indexes of content tokens and to a first orthography and a second inverted index corresponding to phonemic variants of the content tokens and to a second orthography) is used to generate phonemically similar values for the input field. Accordingly, it will be appreciated that various approaches may be used for phonemic fuzzification.

In the context of temporal fuzzification, weighted identity retrieval process 10 generates temporally similar representations based upon, at least in part, variations in a temporal formatting. For example, suppose the input field format is “DDMMYYYY” with two digits for the day, two digits for the month, and four digits for the year. In this example, the input field format is fuzzified into a different format, “MMDDYYY”; “MM-DD-YYYY”; “DD-MM-YY”; a textual representation of the input field format; etc. In one example, weighted identity retrieval process 10 generates temporally similar representations by adding two entries for every date to account for differing formatting standards. For example, the date: Jul. 5, 2024, would result in both variants being added for query purposes: 2024-07-05 and 2024-05-07. In another example, weighted identity retrieval process 10 generates temporally similar representations by adding a number of days (e.g., plus or minus three days) to account for conversion anomalies between different calendar systems.

In the context of verbatim fuzzification, weighted identity retrieval process 10 generates verbatim representations of the input field by changing the case (i.e., uppercase or lowercase) of the input field and/or removing all non-alphanumerical characters (e.g., dashes, spaces, hyphens, etc.). For example, weighted identity retrieval process 10 generates verbatim representations of the input field by removing punctuation and normalizing case. In some implementations, weighted identity retrieval process 10 generates a 26-dimensional vector, with the magnitude of each dimension to represent the number of occurrences of each letter which performs the fuzzification. As shown in FIG. 4, field fuzzifier engine 410 produces fuzzified representation 414.

In some implementations, weighted identity retrieval process 10 enriches the input field of each record (e.g., represented in FIG. 4 with enrichment engine 412). Enriching the input field includes transforming the input field to improve the data quality by removing errors, emptying data fields, or simplifying data. Enriching the input field can include data cleansing (i.e., removing errors and mapping source data to a target data format (e.g., empty data fields transformed to the number “0”)), data deduplication, and/or data formatting (e.g., converting data, such as character sets, measurement units, and date/time values, into a consistent format). In some implementations, enriching the input field is based upon, at least in part, an index type for the input field. In one example and for input fields weighted for the phonemic index, weighted identity retrieval process 10 enriches the input fields using the IPA representation for the input field. In another example and for input fields weighted for the verbatim index, weighted identity retrieval process 10 enriches the input field by setting each character to the uppercase and by removing all non-alphanumerical characters. In another example and for input fields weighted for the temporal index, weighted identity retrieval process 10 enriches the input field by strictly conforming all dates to a predefined format (e.g., “YYYYMMDD”).

In some implementations, weighted identity retrieval process 10 generates 308 a vectorized representation of the input field by vectorizing the fuzzified representation of the input field. This is represented in FIG. 4 with field vectorizer engine 416. Vectorizing is the process of converting textual data into numerical vectors that machine learning models and other algorithms can process efficiently by performing tokenization (i.e., breaking text into individual words or tokens), vocabulary building (i.e., generating a vocabulary including unique words from a corpus where each unique word is assigned a unique index), vectorization (i.e., using one-hot encoding where each word represents a binary vector and/or using word embeddings where each word is assigned a dense vector based on a semantic meaning), and/or normalization (i.e., scaling the vectors to provide uniformity). As will be discussed in greater detail below, vectorized representations allow input fields to be searched using vector-search indexing in an unstructured database.

In some implementations, weighted identity retrieval process 10 indexes 310 the input field in an unstructured database by processing the vectorized representation of the input field. For example, with a vectorized representation of input dataset 402 (e.g., vectorized representation 418), weighted identity retrieval process 10 indexes 310 (i.e., storing an index representation) of vectorized representation 418 into the unstructured database (e.g., database 400). This is represented in FIG. 4 with database indexing engine 420. In some implementations, indexing 310 the input field in the unstructured database includes indexing 312 the vectorized representation of the input field in a phonemic index; indexing 314 the vectorized representation of the input field in a temporal index; and/or indexing 316 the vectorized representation of the input field in a verbatim index.

For example, for vectorized representation 418 with weighting for the phonemic index, weighted identity retrieval process 10 indexes 312 an index representation of vectorized representation 418 in the phonemic index (e.g., phonemic index 422). For instance, weighted identity retrieval process 10 creates a unique entry (i.e., index) within unstructured database 400 (i.e., within phonemic index 422) for vectorized representation 418 including the phonemic weighting value. In another example, for vectorized representation 418 with weighting for the temporal index, weighted identity retrieval process 10 indexes 314 an index representation of vectorized representation 418 in the temporal index (e.g., temporal index 424). For instance, weighted identity retrieval process 10 creates a unique entry (i.e., index) within unstructured database 400 (i.e., within temporal index 424) for vectorized representation 418 including the temporal weighting value. In another example, for vectorized representation 418 with weighting for the verbatim index, weighted identity retrieval process 10 indexes 316 an index representation of vectorized representation 418 in the verbatim index (e.g., verbatim index 426). For instance, weighted identity retrieval process 10 creates a unique entry (i.e., index) within unstructured database 400 (i.e., within verbatim index 422) for vectorized representation 418 including the verbatim weighting value. As will be described in greater detail below, by indexing fuzzified and vectorized representations of each input field of the input dataset, weighted identity retrieval process 10 is able to index all fields independently using the domain model overlay and perform subsequent querying in the unstructured database with three index collections (i.e., a phonemic index, a temporal index, and a verbatim index). Referring again to the flowchart of FIG. 3, following the indexing 124 of the input fields of input dataset 402, weighted identity retrieval process 10 continues to the querying process shown in FIG. 1 (represented by action 318 in FIGS. 1 and 3).

### Query Models

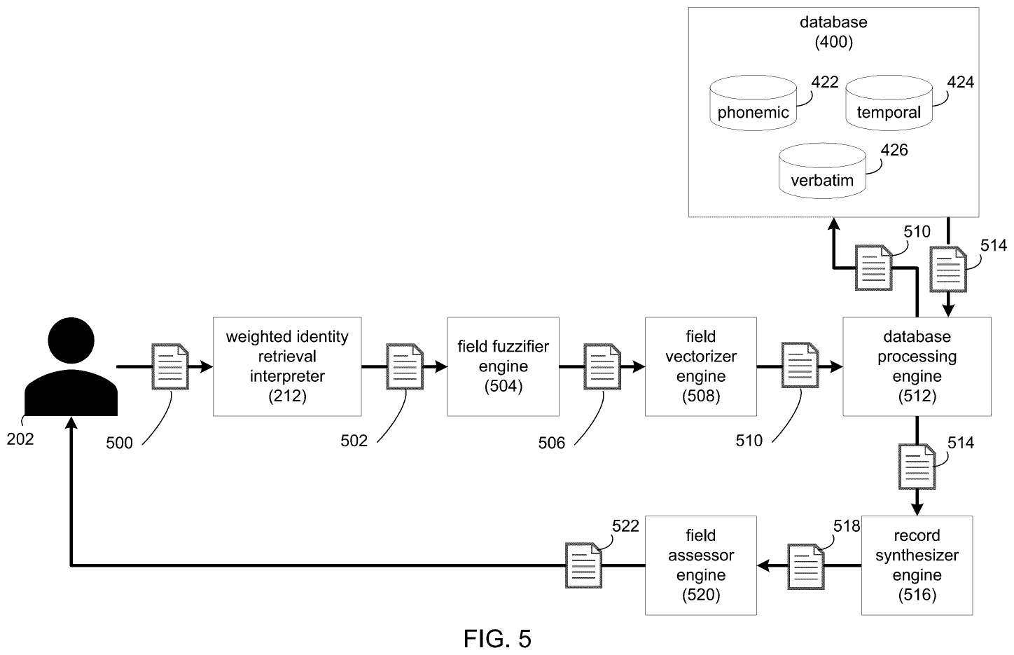

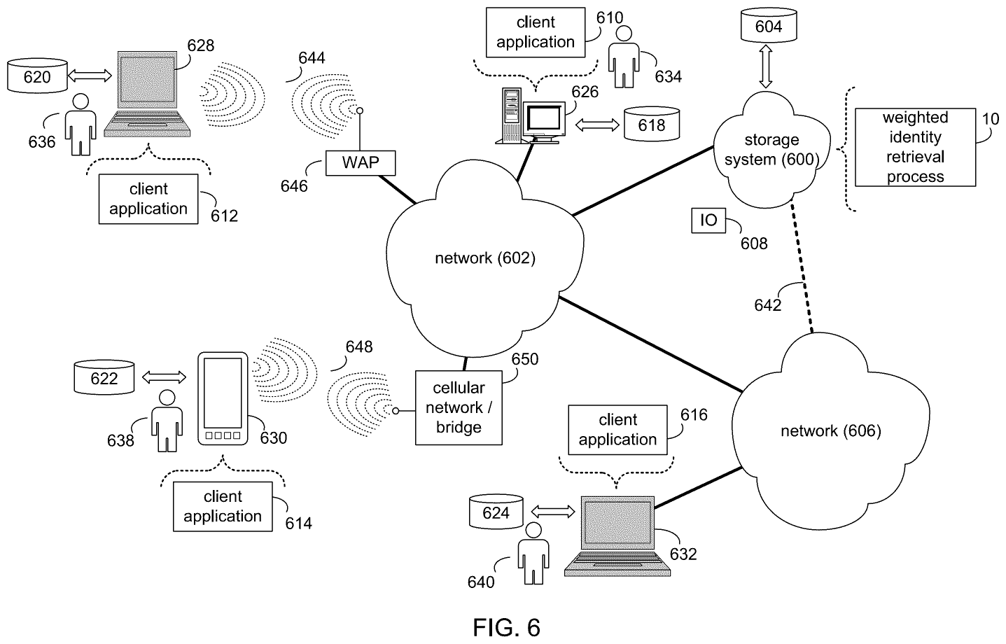

In some implementations, weighted identity retrieval process 10 processes 100 a query for obtaining data from an unstructured database. Referring also to FIG. 5 and in some implementations, weighted identity retrieval process 10 processes 100 a query (e.g., query 500) for obtaining data from an unstructured database (e.g., database 400). In one example, query 500 is received from a user (e.g., a data analyst 200) for obtaining data from database 400. As will be described in greater detail below and as shown in FIG. 5, querying data from database 400 using weighted identity retrieval process 10 includes a sequence of transformations that allow query-defined weighting to focus the retrieval of data from unstructured database 400. As discussed above and in one example, query 500 includes a request for a named entity (e.g., a person name, a country, a company, a proper noun, etc.). As will be discussed in greater detail below and in one example, query 500 includes a weighting for data from database 400. An example of query 500 is provided below:

| “703-555-1212” (80) // match phone with weight override set to 80.
| “Enumclaw” // match city using default weight of 25.
| “WA” // match state using weight of 25.
-> Person THRESHOLD 75 TAKE 100

In this example, query 500 conforms to the formal grammar described above for weighted identity retrieval process 10. In some implementations, non-conforming queries are either automatically revised or rejected with a warning to the requesting user. As shown in the above example query, query 500 includes a query for a person-entity with a number (i.e., “703-555-1212”) with a weighting defined at “80”; a city with no weighting defined, and a state with no weighting defined. In this example and as will be described in greater detail below, one or more thresholds are defined which can override any predefined thresholds associated with a respective domain model.

In some implementations, weighted identity retrieval process 10 generates 102 a parsed representation of a query field of the query by parsing the query field from the query. Continuing with the above example, query 500 includes multiple portions. Accordingly, weighted identity retrieval process 10 (using weighted identity retrieval interpreter 212) converts query 500 from query service 210 multiple fields. For example, weighted identity retrieval process 10 parses query 500 into multiple fields (i.e., parsed representation 502 of query 500).

In some implementations, weighted identity retrieval process 10 generates 104 a fuzzified representation of the query field by fuzzifying the parsed representation of the query field. As discussed above, fuzzifying is the process of introducing variability or imprecision into text data to enhance robustness or address variations in known data types. This is represented in FIG. 5 as “field fuzzifier engine 504”. In some implementations, weighted identity retrieval process 10 fuzzifying a query field includes generating similar representations for the query field. In the example of query 500, weighted identity retrieval process 10 generates a fuzzified representation (e.g., fuzzified representation 506) by fuzzifying each query field (e.g., “703-555-1212”; “Enumclaw”; and “WA”). In one example and as discussed above, weighted identity retrieval process 10 performs phonemic fuzzifying (i.e., by generating phonemically similar representations based upon, at least in part, a phonemic similarity metric and the International Phonetic Alphabet (IPA)); temporal fuzzifying (i.e., by generating temporally similar representations based upon, at least in part, variations in a temporal formatting); and/or verbatim fuzzifying (i.e., by changing the case (i.e., uppercase or lowercase) of the input field and/or removing all non-alphanumerical characters (e.g., dashes, spaces, hyphens, etc.)).

In some implementations, weighted identity retrieval process 10 generates 106 a vectorized representation of the query field by vectorizing the fuzzified representation of the field. This is represented in FIG. 5 with field vectorizer engine 508. As discussed above, vectorizing is the process of converting textual data into numerical vectors that machine learning models and other algorithms can process efficiently. Accordingly, weighted identity retrieval process 10 generates 106 a vectorized representation (e.g., vectorized representation 510) of each query field of query 500. In the above example, weighted identity retrieval process 10 generates a vectorized representation for each query field (e.g., “703-555-1212”; “Enumclaw”; and “WA”) of query 500.

In some implementations, weighted identity retrieval process 10 identifies 108 a matching input field from the unstructured database by querying the unstructured database for the vectorized representation of the query field against a plurality of indexes using a vector search mechanism. For example, with fuzzified and vectorized representations of each query field of query 500, weighted identity retrieval process 10 queries database 400 with vectorized representations 510. This is represented in FIG. 5 with database processing engine 512 that manages the querying of database 400 with vectorized representation 510.

In some implementations, identifying 108 the matching input field from the unstructured database includes querying 114 the unstructured database for the vectorized representation of the field against a phonemic index; querying 116 the unstructured database for the vectorized representation of the field against a temporal index; and/or querying 118 the unstructured database for the vectorized representation of the field against a verbatim index. For example, weighted identity retrieval process 10 queries 114 the unstructured database for vectorized representation 510 against phonemic index 422, queries 116 the unstructured database for vectorized representation 510 against temporal index 424, and/or queries 118 the unstructured database for vectorized representation 510 against temporal index 426. Weighted identity retrieval process 10 identifies any matching input fields (i.e., indexed fields within database 400 that match vectorized representation 510) and returns the matching input field(s) (e.g., matching input field 514) to database processing engine 512 for scoring 110. In some implementations, a vector search mechanism (e.g., Approximate nearest neighbor (ANN), -nearest neighbor (kNN, cosine-similarity, Jaccard-similarity, Manhatten-distance, Hamming-distance, Chebychev-distance), space partition tree and graph, hierarchical navigable small world) is used to identify 108 matching input fields from database 400 for vectorized representation 510. Input fields are matched based on preliminary field-level similarity assessments while identified fields are scored against weights from the domain model and/or from the query model.

In some implementations, weighted identity retrieval process 10 scores 110 the matching input field based upon, at least in part, weighting from a domain model. For example, for each matching input field (e.g., matching input field 514) obtained from the vector search, a weighting is applied to the matching input field and multiplied by the cosine-similarity associated with the matching input field to score 110 matching input field 514. For example and as will be described in greater detail below, without a query weighting provided in query 500, weighted identity retrieval process 10 scores 110 matching input field 514 by applying a default weighting from the domain model and multiplies this value by the cosine-similarity associated with matching input field 514. In this example, the product of the default weighting and the cosine-similarity defines a score for matching input field 514.

In some implementations, scoring 110 the matching input field based upon, at least in part, weighting from a domain model includes processing 120 a weighting provided in the query. Continuing with the above example, suppose that query 500 includes a defined weighting (e.g., “80”) for the query field “703-555-1212” to use instead of the default weighting (e.g., “45”) for phone numbers. In some implementations, processing 120 the weighting provided in the query includes replacing 122 the default weighting in the domain model for the input field with a weighting provided in the query. In this example, weighted identity retrieval process 10 replaces 122 the default weighting in the domain model (e.g., “45”) with the weighting provided in the query (e.g., “80”). In this manner, weighted identity retrieval process 10 allows default weighting in domain models to be used unless a weighting is defined in the query. This allows for weighted identity retrieval of named entities using weighting specified by a user in a query by replacing default weighting in domain models. As such, there is at least a default weighting in the domain model to apply when processing a query unless a query-defined weighting is provided.

For example, suppose weighted identity retrieval process 10 identifies 108 matching input fields (e.g., matching input field 514) corresponding to the input record as shown below:

```
{
  address_and_phone: “100 Main St. / Enumclaw, WA (phone: 571-555-1212)”
  Address: “100 Main St. / Enumclaw, WA”
  Fullname: “John Doe”
  Vehicle: “Ford Explorer”
}
```

In this example, weighted identity retrieval process 10 scores 110 the matching input field based upon, at least in part, weighting from a domain model includes processing 120 the weighting provided in the query as shown below in Table 1:

TABLE 1

| Property | Score | Weight | Weighted score |
|---|---|---|---|
| Person.Phone | 85% | 80 | 68 |
| Person.Address.City | 100% | 10 | 10 |
| Person.Address.State | 100% | 10 | 10 |
| | | cumulative score: | 81 |

As shown above, the weighting provided in query 50 for “Person.Phone” is used to score 110 the obtained phone number (i.e., “571-555-1212”) against the query for (“703-555-1212”) by multiplying the cosine-similarity (i.e., “85%”) by the weight of query 500 (i.e., “80”) to determine a weighted score of “68”. Similar scoring is performed for the “Person. Address.City” and “Person.Address. State” entities to generate weighted scores of “10” for each entity. Weighted identity retrieval process 10 generates a cumulative score for the identified matching input fields. In this example, the cumulative score is “81”.

In some implementations, weighted identity retrieval process 10 provides 112 a weighted result to the query using the scoring of the matching input field. For example, weighted identity retrieval process 10 uses the scoring of the matching input field to generate a weighted result for query 500. In some implementations, weighted identity retrieval process 10 does not return all initially identified records. In this example and as will be described in greater detail below, weighted identity retrieval process 10 provides a high recall initial fetch using fuzzified and vectorized representations of the query (i.e., by providing candidate database fields that are similar due to fuzzification and vectorizing of the query) and a high precision similarity assessment using index-type-specific similarity assessment methodologies (i.e., by using the index and weighting to return the most relevant results from the candidate database fields).

For example and in some implementations, providing 112 the weighted result to the query using the scoring of the matching input field includes comparing 124 the scoring of the matching input field to a threshold associated with the matching input field and providing 126 the weighted result to the query in response to the scoring of the matching input field exceeding the threshold associated with the matching input field. Returning to the above example, where the threshold specified in query 500 is “75” and the cumulative score for the identified record is “81”. In this example, weighted identity retrieval process 10 compares 124 the scoring of the matching input field (i.e., cumulative score of “81”) to the threshold associated with the matching input field (i.e., “75”). Accordingly, because the scoring of the matching input field exceeds the threshold associated with the matching input field, weighted identity retrieval process 10 provides this candidate record as a weighted result to the query. Referring again to FIG. 5, weighted identity retrieval process 10 identifies records associated with matching input field 514. This is shown in FIG. 5 as “record synthesizer engine 516”. Record synthesizer engine 516 synthesizes fields exceeding a threshold into records. In one example, record synthesis is performed by collating matching input fields into groups of candidate records, organized by their dataset coordinates (i.e., input dataset name and record reference/index). In some implementations, matching input fields exceeding the threshold are synthesized into records. For example, suppose a record includes the following information as shown, along with enriched data, in Table 2:

TABLE 2

| Label | Value | Index Type |
|---|---|---|
| Name | Mr. John Smith | Phonemic |
| SSN | 111 22 3456 | Verbatim |
| DOB | Oct. 2, 1997 | Temporal |

In one example, suppose that a query is received that includes “Jon Smythe” “111-22-3546” “February 10, 1997”. When processing this query, weighted identity retrieval process 10 identifies “Record #1” in Table 2 and provides the following matching fields:
{Record: 1, Label: “Name”, Value: “John Smith”}
{Record: 1, Label: “SSN”, Value: “111-22-3456”}
{Record: 1, Label: “DOB”, Value: “1997-10-2”}

In this example, record synthesizer engine 516 synthesizes these fields into a candidate record as shown below in Table 3:

TABLE 3

| Label | Value |
|---|---|
| Record | 1 |
| Name | John Smith |
| SSN | 111-22-3456 |
| DOB | 1997 Oct. 2 |

Accordingly, the reconstituted rows have a reference identifier to retrieve the entire original record (i.e., “Record 1”), but as the values are both normalized and enriched, the reconstituted record is easier to read when collated with other search results. In this manner, the original record is available, but not required for display/rendering when providing the weighted results to the user.

In some implementations, a field type of a query (i.e., name, address, etc.) is only inferred after a field type match above a threshold in a specific index (i.e., phonemic index, temporal index, or verbatim index). For example, during record synthesis, labels are applied to matching fields based upon metadata harvested from the ingestion process described above. Labels for the resulting records are retrieved from a respective specific index match. Each retrieved field in a synthesized object has both a label and a formal “entity.property” name. For example, weighted identity retrieval process 10, during record synthesis, limits matches to a specific entity type. In one example, suppose query 500 is a projection of the Person entity (e.g., for “Jim Ford” where this query concerns “person.name”), weighted identity retrieval process 10 retrieves all high-scoring matches for “Jim Ford”, but not for “Ford Explorer”. Without this projection operator (i.e., entity.property), all records above a threshold would be retrieved, irrespective of entity type. Accordingly, record synthesizer engine 516 provides candidate records (e.g., candidate record 518) to a field assessor engine (e.g., field assessor engine 520). Field assessor engine 520 performs an index-specific assessment for each candidate record (e.g., candidate record 518).

In one example concerning a phonemic index-type for a matching input field, weighted identity retrieval process 10 performs an assessment of candidate record 518 by determining a maximal phonemic sequence (i.e., a fuzzy “sounds-alike” distance metric for phonemic indexes). In another example concerning a temporal index-type for a matching input field, weighted identity retrieval process 10 performs an assessment of candidate record 518 by a vector-search similarity metric (e.g., cosine similarity). In another example concerning a verbatim index-type for a matching input field, weighted identity retrieval process 10 performs an assessment of candidate record 518 by performing the following equation (Equation 1):

$$( ( max ( string length ( string 1 , string 2 ) ) - Levenshtein Distance ( string 1 , string 2 ) ) ) / max ( string length ( string 1 , string 2 ) ) \qquad ( 1 )$$

In this example, two strings (i.e., string1 and string2 corresponding to a string of the matching input field and a string of the query field) are used to determine whether the matching input field of the candidate record and the query field are verbatim. The Levenshtein distance between two words or strings is the minimum number of single-character edits (e.g., insertions, deletions or substitutions) required to change one string into the other. The greater the Levenshtein distance, the less likely that the matching input field is identical to the query field.

In some implementations and in response to the assessment of the candidate records exceeding a threshold, weighted identity retrieval process 10 provides 112 the weighted result as a summation of the scores along with the relevant property text queried for from candidate record 518. This is shown in FIG. 5 as weighted result 522 being provided to user 200.

In some implementations and in addition to user-based queries, weighted identity retrieval process 10 is used for Retrieval-Augmented Generation (RAG) in connection with generative AI models. For example, RAG is a framework that improves the quality of generative AI model responses by grounding the generative AI model on external sources. RAG has two phases: retrieval and content generation. In the retrieval phase, algorithms search for and retrieve portions of information relevant to a prompt or question. In an open-domain setting, results and answers to the prompt can come from indexed documents on the internet; and in a closed-domain, a narrower set of sources are typically used for added security and reliability. Accordingly and in one example, weighted identity retrieval process 10 augments RAG by processing a query in the form of a prompt provided to a generative AI model when obtaining data responsive to the prompt from database 400 in the manner described above. In some implementations, the generative AI model includes a Large Language Model (LLM). A LLM (e.g., GPT-4 from OpenAI®, OpenLLaMa, and Cerebras-GPT) is a language model consisting of a neural network with many parameters (typically billions of weights or more), trained on large quantities of unlabeled and/or labeled text using self-supervised learning, semi-supervised learning, and/or fine-tuning of the weights to cater the neural network for particular tasks or workloads.

In this example, with database 400 being managed during ingestion of input datasets, weighted identity retrieval process 10 provides enhanced (i.e., in terms of a grounded input dataset in database 400 and in terms of performance by obtaining data from unstructured database 400) results to a prompt provided by a generative AI model. For example, weighted identity retrieval process 10 provides weighted results from database 400 for combining with the query to generate a prompt for processing by the generative AI model. In some implementations, weighted identity retrieval process 10 is applied to a multi-lingual system, where named entity recognition (NER) is used in the RAG pipeline, by performing phonemic fuzzification (as described above) on all recognized named entities inside of the RAG pipeline. Similarly, in multi-lingual or mono-lingual systems, weighted identity retrieval process 10 is used as the result of NER to perform date fuzzification and verbatim fuzzification (i.e., for a SSN, a phone number, a passport number, a globally unique identifier (GUID), etc.).

In another example, weighted identity retrieval process 10 is used to perform “N”-shot prompting for a generative AI model. For example, “N”-shot prompting includes providing a number of examples (i.e., “N” examples, which is a predefined value) for processing by the generative AI model along with the query. In this manner, the “N” examples help “teach” the generative AI model to generate similar responses to the examples provided. In one example, weighted identity retrieval process 10 provides “N” examples from database 400 that are similar to query 500 by providing the weighted result(s) to the query to the generative AI model for processing. Using these “N” prompts and corresponding examples of expected outputs, weighted identity retrieval process 10 provides a prompt for processing using the generative AI model that is expected to generate an output that is consistent with the expected outputs.

### System Overview

Referring to FIG. 6, a weighted identity retrieval process 10 is shown to reside on and is executed by storage system 600, which is connected to network 602 (e.g., the Internet or a local area network). Examples of storage system 600 include: a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of storage system 600 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of weighted identity retrieval process 10, which are stored on storage device 604 included within storage system 600, are executed by one or more processors (not shown) and one or more memory architectures (not shown) included within storage system 600. Storage device 604 may include: a hard disk drive; an optical drive; a RAID device; a random-access memory (RAM); a read-only memory (ROM); and all forms of flash memory storage devices. Additionally or alternatively, some portions of the instruction sets and subroutines of weighted identity retrieval process 10 are stored on storage devices (and/or executed by processors and memory architectures) that are external to storage system 600.

In some implementations, network 602 is connected to one or more secondary networks (e.g., network 606), examples of which include: a local area network; a wide area network; or an intranet.

Various input/output (IO) requests (e.g., IO request 608) are sent from client applications 610, 612, 614, 616 to storage system 600. Examples of IO request 608 include data write requests (e.g., a request that content be written to storage system 600) and data read requests (e.g., a request that content be read from storage system 600).

The instruction sets and subroutines of client applications 610, 612, 614, 616, which may be stored on storage devices 618, 620, 622, 624 (respectively) coupled to client electronic devices 626, 628, 630, 632 (respectively), may be executed by one or more processors (not shown) and one or more memory architectures (not shown) incorporated into client electronic devices 626, 628, 630, 632 (respectively). Storage devices 618, 620, 622, 624 may include: hard disk drives; tape drives; optical drives; RAID devices; random access memories (RAM); read-only memories (ROM), and all forms of flash memory storage devices. Examples of client electronic devices 626, 628, 630, 632 include personal computer 626, laptop computer 628, smartphone 630, laptop computer 632, a server (not shown), a data-enabled, and a dedicated network device (not shown). Client electronic devices 626, 628, 630, 632 each execute an operating system.

Users 634, 636, 638, 640 may access storage system 600 directly through network 602 or through secondary network 606. Further, storage system 600 may be connected to network 602 through secondary network 606, as illustrated with link line 642.

The various client electronic devices may be directly or indirectly coupled to network 602 (or network 606). For example, personal computer 626 is shown directly coupled to network 602 via a hardwired network connection. Further, laptop computer 632 is shown directly coupled to network 606 via a hardwired network connection. Laptop computer 628 is shown wirelessly coupled to network 602 via wireless communication channel 644 established between laptop computer 628 and wireless access point (e.g., WAP) 646, which is shown directly coupled to network 602. WAP 646 may be, for example, an IEEE 802.11a, 802.11b, 802.11g, 802.11n, Wi-Fi®, and/or Bluetooth® device that is capable of establishing a wireless communication channel 644 between laptop computer 628 and WAP 646. Smartphone 630 is shown wirelessly coupled to network 602 via wireless communication channel 648 established between smartphone 630 and cellular network/bridge 650, which is shown directly coupled to network 602.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

1. A computer-implemented method, executed on a computing device, comprising:
processing a query for obtaining data from an unstructured database;
generating a parsed representation of a query field of the query;
generating a fuzzified representation of the parsed representation of the query field, wherein a fuzzification type to perform on the parsed representation of the query field is determined based on a weighting assigned to the query field;
generating a vectorized representation of the fuzzified representation of the query field;
identifying a matching input field from the unstructured database by querying the unstructured database for the vectorized representation of the query field against a plurality of indexes using a vector search mechanism, wherein the plurality of indexes includes at least one of a phonemic index or a temporal index;
scoring the matching input field based upon, at least in part, weighting from a domain model; and
providing a weighted result to the query using the scoring of the matching input field.

2. The computer-implemented method of claim 1, wherein the plurality of indexes further includes a verbatim index.

3. The computer-implemented method of claim 1, further comprising:
processing an input dataset by identifying a record from the input dataset;
generating a fuzzified representation of an input field;
generating a vectorized representation of the fuzzified representation of the input field; and
indexing the input field in an unstructured database by processing the vectorized representation of the input field.

4. The computer-implemented method of claim 3, wherein processing the input dataset includes defining a domain model for the input field with a default weighting.

5. The computer-implemented method of claim 4, wherein scoring the matching input field includes processing a weighting provided in the query.

6. The computer-implemented method of claim 5, wherein processing the weighting provided in the query includes replacing the default weighting in the domain model for the input field with the weighting provided in the query.

7. The computer-implemented method of claim 1, wherein providing the weighted result to the query using the scoring of the matching input field includes:
comparing the scoring of the matching input field to a threshold associated with the matching input field; and
providing the weighted result to the query in response to the scoring of the matching input field exceeding the threshold associated with the matching input field.

8. A computing system comprising:
a memory; and
a processor configured to:
process an input dataset by identifying a record from the input dataset;
generate a fuzzified representation of an input field;
generate a vectorized representation of the fuzzified representation of the input field; and
index the input field in an unstructured database by processing the vectorized representation of the input field.

9. The computing system of claim 8, wherein processing the input dataset includes defining a domain model for the input field with a default weighting.

10. The computing system of claim 9, wherein defining the domain model for the input field includes generating the default weighting using a generative AI model.

11. The computing system of claim 8, wherein indexing the input field in the unstructured database includes indexing the vectorized representation of the input field in a phonemic index.

12. The computing system of claim 8, wherein indexing the input field in the unstructured database includes indexing the vectorized representation of the input field in a temporal index.

13. The computing system of claim 8, wherein indexing the input field in the unstructured database includes indexing the vectorized representation of the input field in a verbatim index.

14. The computing system of claim 8, wherein the processor is further configured to:
process a query for obtaining data from an unstructured database;
generate a parsed representation of a query field of the query;
generate a fuzzified representation of the parsed representation of the query field. wherein a fuzzification type to perform on the parsed representation of the query field is determined based on a weighting assigned to the query field;
generate a vectorized representation of the fuzzified representation of the field;
identify the input field from the unstructured database by querying the unstructured database for the vectorized representation of the query field against a plurality of indexes using a vector search mechanism, wherein the plurality of indexes includes at least one of a phonemic index or a temporal index;
score the input field based upon, at least in part, weighting from a domain model; and
provide a weighted result to the query using the scoring of the input field.

15. A computer program product residing on a computer readable medium having a plurality of instructions stored thereon which, when executed by a processor, cause the processor to perform operations comprising:
processing an input dataset by identifying a record from an input dataset;
generating a fuzzified representation of an input field in the record;
generating a vectorized representation of the fuzzified representation of the input field; and
indexing the input field in an unstructured database by processing the vectorized representation of the input field;
processing a query for obtaining data from an unstructured database;
generating a parsed representation of a query field by parsing the field in the query;
generating a fuzzified representation of the parsed representation of the query field, wherein a fuzzification type to perform on the parsed representation of the query field is determined based on a weighting assigned to the query field;
generating a vectorized representation of the fuzzified representation of the query field;
identifying the input field from the unstructured database by querying the unstructured database for the vectorized representation of the query field against a plurality of indexes using a vector search mechanism, wherein the plurality of indexes includes at least one of a phonemic index or a temporal index;
scoring the input field based upon, at least in part, weighting from a domain model associated with the input field; and
providing a weighted result to the query using the scoring of the input field.

16. The computer program product of claim 15, wherein the plurality of indexes further includes a verbatim index; and
wherein identifying the input field comprises querying the unstructured database for the vectorized representation of the query field against the verbatim index.

17. The computer program product of claim 15, wherein processing the input dataset includes defining a domain model for the input field with a default weighting.

18. The computer program product of claim 17, wherein scoring the matching input field includes processing a weighting provided in the query.

19. The computer program product of claim 18, wherein processing the weighting provided in the query includes replacing the default weighting in the domain model for the input field with the weighting provided in the query.

20. The computer program product of claim 15, wherein providing the weighted result to the query using the scoring of the matching input field includes:
comparing the scoring of the matching input field to a threshold associated with the matching input field; and
providing the weighted result to the query in response to the scoring of the matching input field exceeding the threshold associated with the matching input field.
